(19) United States
(12) Patent Application Publication
(10) Pub. No.: US 2004/0193902 A1
(43) Pub. Date: Sep. 30, 2004

(54) Digital content rendering device and method

(76) Inventors: Dean H. Vogler, Algonquin, IL (US); Ephrem A. Chemaly, Lake in The Hills, IL (US); Ezzat A. Dabbish, Cary, IL (US); Thomas S. Messerges, Schaumburg, IL (US); Robert A. Patzer, Lake Zurich, IL (US)

Correspondence Address: MOTOROLA, INC., 1303 EAST ALGONQUIN ROAD, IL01/3RD, SCHAUMBURG, IL, 60196

(21) Appl. No.: 10/403,332

(22) Filed: Mar. 31, 2003

(51) Int. Cl. H04L 9/32

(52) U.S. Cl. 713/193

(57) ABSTRACT

A preferred technique includes a digital content rendering device (100) and a method used in the device, including acquiring (305) an encrypted digital content (105), acquiring (305) a set of rules (110) associated with the encrypted digital content that specify permissions involving at least one level of rendering of the digital content that are based on a comparison of a set of specified locations with a sensed location, acquiring (305) an encrypted content key (120), extracting (315) the digital content, determining (330) a sensed location of the content rendering device, performing comparisons (335) of the sensed location to each of the set of specified locations; and determining (340) a level of rendering of the digital content in accordance with the set of rules, based on results of the comparisons.

### BACKGROUND

Digital Rights Management (DRM) is a technology used to describe the available rights and the management of rules related to accessing and processing digital items. Digital items, also called digital content, include such things as music, video, software, books, and games. Content owners expect to be able to protect their valuable digital content using DRM. The rules might also be described as license rules, since they determine specific situations in which a user may use digital content, under license from the content owner. Digital content may be assigned user rights (digital rights) such as play, loan, or install. Digital rights can have many attributes such as “play 5 times only”, “unlimited play for the next 2 months”, or “allow streaming but do not store”. Attributes allow content owners to fine-tune the delivery and rendering of digital content. In a secure DRM system, the DRM software is expected to obey the rights and attributes assigned to the digital content and to be trusted (that is, immune to unauthorized changes). The DRM software is said to be “trusted”. So, for example, if a digital content's rule indicates that the content can only be played until the end of the current month, the DRM software is expected to enforce the rule and disallow any rendering of the content when the event occurs. Naturally, the DRM software cannot enforce this rule without some additional help, namely a clock device. For example, a cellular telephone will have to have access to current time and date information in order for a DRM module to enforce this rule.

There are a number of advanced attributes, important in the operation of DRM rules that require support external to the DRM software in order for the DRM software to be able to enforce the rules. As mentioned, rules based on time and date are examples that require access to a clock. Another important DRM attribute is that of geographic location. WO0237246 publication entitled “System and method for using location identity to control access to digital information” describes a system that permits access to “geolocked” digital information only at a specified geographic location. In one embodiment of WO0237246, the digital information is encrypted using a location-based encryption key so that it can only be accessed by using the location-based encryption key. In the other embodiment, the digital information is accessible only at a specific location, and is otherwise inaccessible. While this document describes a technique that provides some value, it has shortcomings that involve the use of location and the rendering of the digital information.

### BRIEF DESCRIPTION OF THE DRAWINGS

The present invention is illustrated by way of example and not limitation in the accompanying figures, in which like references indicate similar elements, and in which:

FIG. 1 shows a block diagram of a content rendering device 100, in accordance with the preferred embodiment of the present invention.

FIG. 2 shows a flow chart of a method of generating the protected digital content for delivery to the content rendering device, in accordance with the preferred embodiment of the present invention.

FIG. 3 shows a flow chart of a method of rendering the protected digital content by the content rendering device, in accordance with the preferred embodiment of the present invention.

FIG. 4 shows a topographic diagram that illustrates a first exemplary set the rules, in accordance with the preferred embodiment of the present invention.

FIG. 5 shows a topographic diagram that illustrates a second exemplary set of rules, in accordance with the preferred embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular digital content rendering technology in accordance with the present invention, it should be observed that the present invention resides primarily in combinations of method steps and apparatus components related to rendering digital content. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

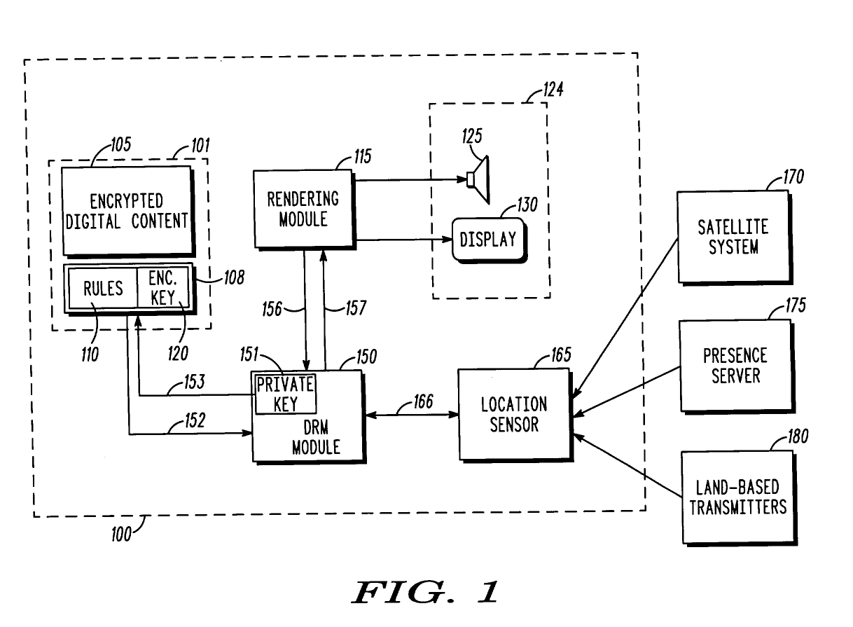

Referring to FIG. 1, a block diagram of a content rendering device 100 is shown, in accordance with the preferred embodiment of the present invention. The content rendering device 100 comprises a content acquisition area 101, a content rendering module 115, user interface components 124, a digital rights module 150, and a location sensor 165. The content acquisition area 101 provides for the storage of encrypted digital content 105 and a rights object 108 that is associated with the encrypted digital content 105, which together are called a protected digital content. The rights object 108 preferably comprises a set of rules 110, an encrypted content key 120, and a digital signature. The encrypted digital content 105 and the rights object 108 are received or acquired by the content rendering device 100, typically from a remote location (e.g., by means of a communication network), from a removable media device that can be loaded into the content rendering device (e.g., as an insertable read-only memory in the form of an integrated circuit memory module or a disk memory), or from onboard memory (e.g., flash memory within the content rendering device). The rights object 108 can be received in a file with the encrypted digital content 105, or in a separate file that includes an identification of association with the encrypted digital content 105. The encrypted digital content 105 can be quite temporary, as it would be when it is a portion of a streaming digital content being rendered by the content rendering device 100. Rendering, as used herein means delivery of the digital content to another digital device or presentation of the digital content to a user, such as for example, an audio presentation of music, a visible presentation of text and graphics, an audio/visual presentation of a movie, or an interaction audio/visual presentation of a game. Rendering may be performed at various levels, including a complete rendering, as described in more detail below. In the instance of streaming encrypted digital content 105, the associated set of rules 110 are likely (but not required to be) static in comparison to the streaming digital content, and thus may be received when the streaming digital content starts to be received by the content rendering device 100. The content acquisition area 101 may be a random access memory for holding a file that is a portion of a streaming digital content, or a file that is a complete non-streaming digital content. The content acquisition area 101 may alternatively be a cavity with an electronic connector or other physical arrangement designed for a pluggable memory that contains an encrypted digital content 105 and may also contain the associated rights object 108 (or the associated rights object 108 could be loaded into random access memory that is another portion of the content acquisition area 101 after being received over a communication network).

When the protected digital content is received or otherwise acquired (e.g., inserted) and stored within the content acquisition area 101, information within the rights object 108 and encrypted digital content 105 can be coupled to the DRM module 150 by signals 152 under control of signals 153 from the DRM module 150. The content rendering module 115 is coupled to the DRM module by signals 156, 157. The DRM module 150 can route the digital content data from the content acquisition area 101 to the content rendering module 115. The content rendering module 115 is coupled to user interface components 124, which in this example of a content rendering device 100 are a speaker 125 and a display 130, but which could also or alternatively include, for example keys, a keyboard, indicator lights, and/or switches.

The location sensor 165, which is coupled to the DRM module 150 by signals 166, is capable of receiving or otherwise acquiring location information. The location information can be, for example, earth surface position information received from the global position satellite (GPS) system 170, or presence server information from a presence server 175, or position information received from any of a large variety of land-based transmitting systems 180 that identify a location by either proximity to a fixed identifiable transmitter, or by position information conveyed by the signals. Presence servers are known in the art of cellular telephone systems as servers that maintain information about telephones that are active within a system. User provided or network provided location information about active telephones is typically included in the attributes that can be stored in a presence server. Examples of land based transmitting systems that identify a location by proximity to a fixed identifiable transmitter, that is by the action of receiving a decodable signal (i.e., “being within range”) that identifies a particular transmitter (or cell), include many land based communication systems (cellular, wireless data, paging, and some local wireless area networks). Examples of land based transmitting systems that transmit position information in the signals are LORAN and TACAN systems (operated by the government primarily for military purposes).

The elements described above as being portions of the content rendering device 100 (the content acquisition area 101, the content rendering module 115, the DRM module 150, the location sensor 165, and the user interface components 124) are embodied as a combination of electronic components that include at least one processor and a number of sets of program instructions that are stored in non-volatile memory. The location sensor 165 typically includes an integrated radio receiver, and there can be a radio receiver for receiving the encrypted digital content 105 and/or the rights object 108.

There is significant benefit to be derived for a content provider in having the flexibility to control the location at which content is rendered (or not rendered) to the user, and to control the level of rendering that is allowed at a location or locations. This is explained in more detail below. In order to have the assurance of this control, the digital content is preferably transferred to the content rendering device 100 in an encrypted form, the rights object 108 is cryptographically protected, and the content rendering device 100 includes a trusted platform for controlling the rendering according to the sensed location and the set of rules 110 within the rights object 108. “A trusted platform” means that the content provider has adequate assurance that the combination of electronic components needed to render the digital contents for the user will do so only according to the set of rules 110 that are a part of the rights object 108 that is associated with encrypted digital content 105 stored in the content acquisition area 101 of the user's content rendering device 100. In order to provide this assurance, the trusted platform typically includes hardware protection and software security techniques that are invoked (via program instructions) every time that the content rendering device 100 is powered up. The software security techniques test every critical set of program instructions and every critical electronic component used to render the content in order to validate that they have not been changed from the time the content rendering device was manufactured (by a trusted facility) or serviced by a trusted service agency. Critical sets of program instructions and critical electronic components are those for which tampering could result in a user being able to render the content other than according to the set of rules 110 associated with the encrypted digital content 105. For example, the DRM module 150, location sensor 165, the content rendering module 115, the content acquisition area 101, and the signals coupling these are within the trusted platform, while a battery (not shown in FIG. 1) that powers the content rendering device 100 is not a part of the trusted platform.

As mentioned above, the digital contents are encrypted before they are acquired by the content rendering device 100. For optimal performance characteristics, the encryption is preferably done using a symmetric algorithm (e.g. well-known algorithms identified as AES, RC4, DES); wherein the key that is used to generate the encrypted digital content 105 is used to decrypt the encrypted digital content 105. This key, known as the content key, is provided to the content rendering device 100 in the form of the encrypted content key 120 that is a part of the rights object 108. The content key is encrypted using well-known public-key encryption security technology. A public key of the content rendering device is used by the protected digital content creator to generate the encrypted content key 120. The content rendering device 100 includes a complementary private key 151 of the public key used to encrypt the content key. Private key 151 is used to decrypt the encrypted content key 120, to obtain the content key. The private key 151 is a part of the trusted platform of the content rendering device 100. In FIG. 1 private key 151 is shown to be a part of the DRM module 150, but it could equally well be within another portion of the trusted platform. In order to provide assurance that neither the set of rules 110 nor the encrypted content key 120 are altered prior to use by the content rendering device 100, the rights object 108 contains a digital signature that is verified by the DRM Module 150 before the set of rules 110 or the encrypted content key 120 are used.

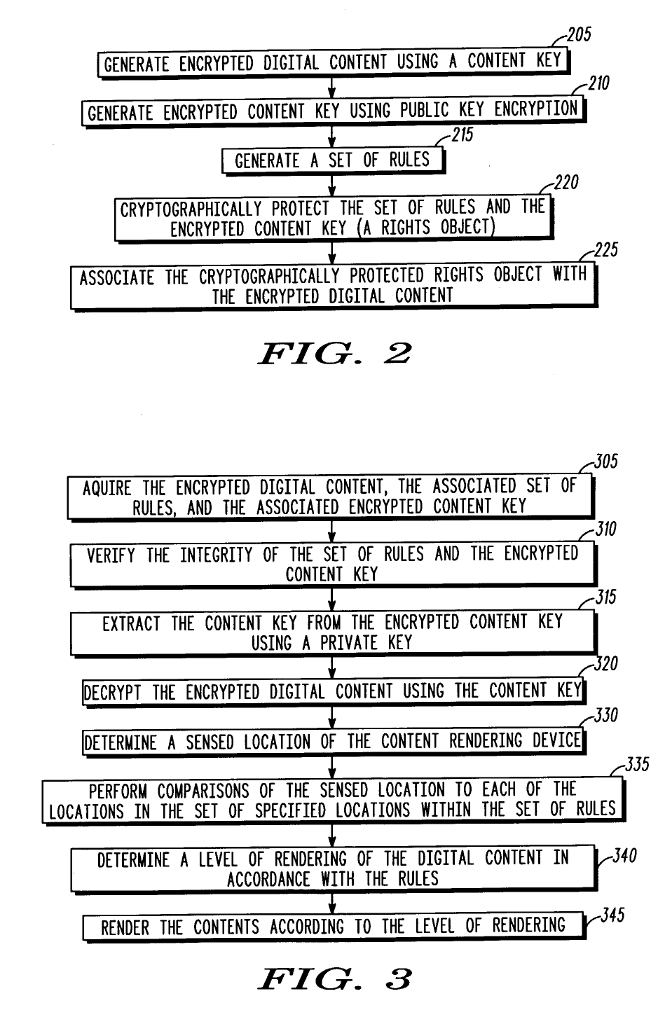

Referring to FIG. 2, a flow chart of a method of generating the protected digital content for delivery to the content rendering device 100 is shown, in accordance with the preferred embodiment of the present invention. At step 205, encrypted digital content 105 is generated by encrypting a digital content with a content key. The content key that is used is preferably for a symmetric encryption algorithm. The encrypted content key 120 is then generated at step 210 by public-key encryption; the public key that is used is a public key of the content rendering device 100. The set of rules 110 are generated at step 215. The set of rules include a set of specified locations and a plurality of levels of content rendering. There may also be rules unrelated to location-based events within the set of rules. Generating the set of rules 110 is independent of choosing the content encryption key or of encrypting the digital content. More description of the set of locations and levels of rendering of the digital content included in the set of rules is provided below. At step 220, the rights object 108 (the set of rules 110 and the encrypted content key 120) is cryptographically protected from tampering by the well-known technique of digitally signing the rights object 108. The cryptographically protected rights object 108 is associated with the encrypted digital content 105 at step 225. The rights object 108 can be associated with the encrypted digital content 105 by being included within the same file or folder, or by identifying the file which includes the encrypted digital contents, such as by using a filename or other well-known linking technique, or by some inclusion of an identifier or metadata in both the rights object 108 and the encrypted digital content 105.

Referring to FIG. 3, a flow chart of a method of rendering the protected digital content by the content rendering device 100 is shown, in accordance with the preferred embodiment of the present invention. At step 305, the encrypted digital content 105 and the associated set of rules 110 and the encrypted content key 120 are acquired by the content rendering device 100, either by a communication network, or by being electrically coupled, manually, to the content-rendering device 100 (as by insertion of a game module in a cavity of the content rendering device, or a mating of electrical connectors between an external disk drive and the content rendering device). The content rendering device 100 then verifies the integrity of the set of rules 110 and encrypted content key 120 at step 310 using a digital signature verification technique. At step 315, the content key is extracted from the encrypted content key 120 by using the private key 151 of the content rendering device 100 to decrypt the encrypted content key. The encrypted digital content 105 can be decrypted at step 320 using the content key. In order to render the digital contents at a rendering level in accordance with the set of rules 110, the content rendering device 100 at step 330 determines a sensed location of the content rendering device 100, and performs comparisons of the sensed location to each of the locations in the set of specified locations within the set of rules 110 at step 335. The content rendering device 100 then determines at step 340 a level of rendering of the digital content in accordance with the rules based on the comparisons of the locations, and renders the contents through signal 157 according to the level, at step 345. The start of such rendering may be under control of the user or may be automatically controlled by time, location, or other environmental parameter. The determining of the sensed location, the performing of the comparisons, and the determining of the level of rendering are performed within the trusted platform of the content rendering device 100. The content key is independent of the set of specified locations. This allows the digital contents to be decrypted independently from the determination of the sensed location, which provides a benefit over prior art technologies that make the decryption key dependent upon location. In some cases the content rendering device 100 is mobile and its location can vary. Therefore, the sensed location may periodically be compared to the location in the rules and thereby enable the rendering level to change while the content is being rendered.

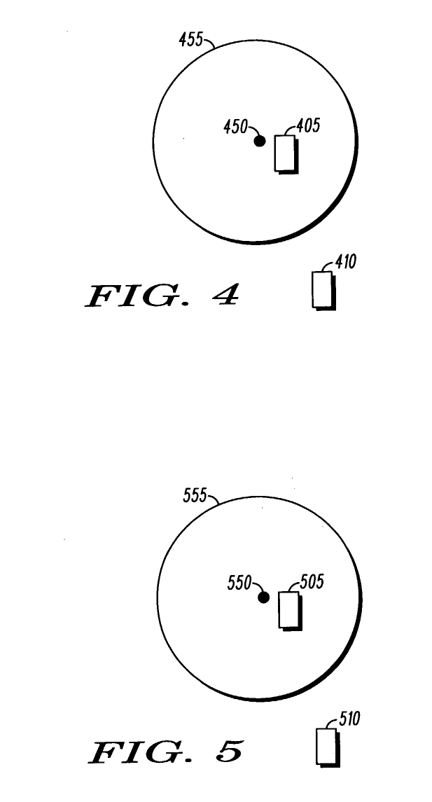

Referring to FIG. 4, a topographic diagram is shown that illustrates a first exemplary set of rules 110, in accordance with the preferred embodiment of the present invention. Two content rendering devices 405, 410 are implemented as described above with reference to content rendering device 100 and they each contain an identical first exemplary set of rules 110 that have been acquired by the content rendering devices 405, 410, along with associated encrypted digital content. In this example, the content rendering devices 405, 410 are processing devices that can wirelessly access the Internet, the location sensors 165 are GPS sensors, and the encrypted digital contents 105 are utility programs controlled by a mall operator that can display an inventory of user selected consumer goods available at a mall. The first exemplary set of rules 110 state that the encrypted digital content 105 can be rendered at a first rendering level when the content rendering devices 405, 410 are at a first specified location and the encrypted digital content 105 can be rendered at a second rendering level when the content rendering devices 405, 410 are not at the first specified location. The first location is specified as being any point within a defined proximity of a specific set of GPS coordinates. The proximity can be stated in a manner to provide essentially any desired shape to the first location, but in this example, the first location is shown having a circular periphery 455 around a GPS determined set of geographic coordinates shown as a small circle 450. In this example, the first location is one that includes the mall stores. When the content rendering device 410 compares this location to the sensed coordinates, it determines that its location does not match the first location, and therefore, although it may download the prices and quantities of a particular type of goods selected by the user, it can only indicate that some are available at the mall. When the content rendering device 405 compares this location to the sensed coordinates, it determines that its location does match the first location (i.e., is within proximity of the coordinates), and therefore it may download a list showing the quantities of a particular type of goods selected by the user, the stores at which they are located, and their prices.

Thus, in accordance with this example of the present invention, the encrypted digital content 105 becomes accessible to the content rendering module 115 when the encrypted content key 120 is decrypted (irrespective of the sensed location of the content rendering device 100) and the content rendering module 115 renders the digital content at the second level when the sensed location is determined not to be the specified location, and renders the digital content at the first level when the sensed location is determined to be the specified location. It will be appreciated that the number of levels of rendering could be greater than the two levels described above, in some circumstances. For example, a content rendering device in accordance with an embodiment of the present invention that includes game content could support a plurality of levels of rendering that amount to being able to play the game at different levels dependent upon which of a plurality of locations the player is at. Such locations could be independent geographical positions, or using different proximity definitions, a plurality of diminishing regions around a common geographical positions, or a combination of these two types of locations. This feature of plural levels of rendering is easily done when the decryption key for the encrypted digital content 105 is independent of a specified location.

Referring to FIG. 5, a topographic diagram is shown that illustrates a second exemplary set of rules 110, in accordance with the preferred embodiment of the present invention. Two content rendering devices 505, 510 are implemented as described above with reference to content rendering device 100 and they contain an identical second set of rules 110 that have been acquired by the content rendering devices 505, 510, along with associated encrypted digital content 105. In this example, the content rendering devices are television cable set top boxes, the location sensors 165 are GPS sensors, and the encrypted digital contents 105 are television broadcasts of a sports event. The second exemplary set of rules 10 states that the encrypted digital content 105 cannot be rendered when the content rendering devices 505, 510 are at a first specified location and the encrypted digital content 105 can be rendered at a first rendering level when the content rendering devices 505, 510 are not at the first specified location. The first location is again specified as being any point within a defined proximity of a specific set of GPS coordinates. In this example, the first location is shown having a circular periphery 555 around a GPS determined set of geographic coordinates shown as a small circle 550. In this example, the first location is one that includes a town in which the sports event is being held and for which not all the seats were sold and a blackout condition is imposed for the geographic area. When the content rendering device 505 compares the first location to the sensed coordinates, it determines that its sensed location does match the first location, and therefore, although the contents can be decrypted, they are not rendered at all. When the content rendering device 510 compares the first location to the sensed coordinates, it determines that its sensed location does not match the first location (i.e., it is outside the proximity of the coordinates), and therefore it may display the television broadcast of the sports event to the user.

Thus, in accordance with this example of the preferred embodiment of the present invention, the encrypted digital content 105 becomes accessible to the content rendering module 115 when the encrypted content key 120 is decrypted (irrespective of the sensed location of the content rendering device 100) and the content rendering module 115 does not render the digital content when the sensed location is determined to be the specified location.

In another example in accordance with the preferred embodiment of the present invention similar to that described with reference to FIG. 5, there could be a second specified location at which a second level of rendering is performed. For example, the second level of rendering could be one for which the television broadcast is shown without commercial interruption while the first level has commercial interruptions but is free to view.

Thus, instead of one level of rendering as described with reference to FIG. 5, this example has two levels of rendering, and a specified location at which rendering is not permitted. In accordance with the preferred embodiment of the present invention, the prohibition of rendering of any digital content, or simply not rendering any digital content, is not a “level of rendering” as that term is used herein. To further clarify, “a level of rendering” as used herein describes actual rendering of the digital content in full or in some part.

In an alternative embodiment, the apparatus described with reference to FIG. 1 and the methods described with reference to FIGS. 2 and 3 are modified to eliminate the encryption aspects of the present invention. This can be beneficial, for example, in a situation in which the content provider provides a content rendering device that already contains digital content that has been placed within the content rendering device using a trusted procedure (for instance, at a factory run by the content provider). This type of digital content rendering device could be used, for example, at a theme park owned by the content provider, wherein the use is such that the provider has adequate assurance that the security of the content cannot be breached—e.g., the content rendering device is loaned out for a short period of time.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. A “set” as used herein, means a non-empty set (i.e., for the sets defined herein, comprising at least one member).

What is claimed is:

1. A method for digital content rendering, comprising:
acquiring a digital content;
acquiring a set of rules associated with the digital content that specify permissions involving at least one level of rendering of the digital content, at least one permission being based on a comparison of a set of specified locations with a sensed location;
determining a sensed location of a content rendering device;
performing comparisons of the sensed location to each of the set of specified locations; and
determining a level of rendering of the digital content in accordance with the set of rules, based on results of the comparisons.

2. The method for digital content rendering according to claim 1, wherein a rendering of the digital content is prohibited according to a rule in the acquired set of rules, when a result of a comparison is a match between the sensed location and one of the set of specified locations.

3. The method for digital content rendering according to claim 1, wherein a first level of rendering is determined according to a rule in the set of acquired rules when a result of a comparison is no match between the sensed location and any one of the set of specified locations and a second level of rendering is determined according to a rule in the set of acquired rules when a result of a comparison is a match between the sensed location and any one of the set of specified locations.

4. The method for digital content rendering according to claim 1, wherein at least two levels of rendering are determined according to the set of acquired rules, the two levels of rendering corresponding to comparisons between the sensed location and corresponding locations of the set of specified locations.

5. The method for digital content rendering according to claim 1,
wherein the determination of the sensed location and the performing comparisons are done within a trusted platform of a content rendering device, and
wherein the digital content is encrypted with a content key that is independent of the set of specified locations, and wherein the content key is encrypted with a public key of the content rendering device, and wherein the set of rules and the encrypted content key are cryptographically protected, further comprising:
verifying the integrity of the set of rules and encrypted content key;
extracting the content key from the encrypted content key using a private key of the content rendering device; and
decrypting the encrypted digital content using the content key.

6. The method for digital content rendering according to claim 1, wherein a result of a comparison is a match when the sensed location and one location of the set of specified locations differ by less than a proximity value.

7. A method for generating encrypted digital content, comprising:
generating encrypted digital content by encrypting a digital content with a content key;
encrypting the content key by using a public key of a content rendering device;
generating a set of rules that specify permissions that involve at least one level of rendering of the digital content that are based on a comparison of a set of specified locations with a sensed location;
cryptographically protecting the integrity of a set of rules and the encrypted content; and
associating the cryptographically protected set of rules and the encrypted content key with the encrypted digital content.

8. The method for generating encrypted digital content according to claim 7, wherein the set of rules includes a rule in which rendering is prohibited when a result of a comparison is a match between the sensed location and one of the set of specified locations.

9. The method for generating encrypted digital content according to claim 7, wherein the set of rules includes a rule in which a first level of rendering is imposed when a result of a comparison is no match between the sensed location and any one of the set of specified locations and a rule in which a second rendering level is imposed when a result of a comparison is a match between the sensed location and any one of the set of specified locations.

10. The method for digital content rendering according to claim 7, wherein the set of rules includes at least two levels of rendering that correspond to comparisons between the sensed location and corresponding locations of the set of specified locations.

11. The method for digital content rendering according to claim 7, wherein at least one location in the set of specified locations includes at least one proximity value.

12. A digital content rendering device, comprising:
a content acquisition area that can acquire a digital content, and a set of rules associated with the digital content that specify permissions involving at least one level of rendering of the digital content, at least one permission being based on a comparison of a set of specified locations with a sensed location; and
a processor and associated instructions that, after the digital content rendering device has acquired a digital content and an associated set of rules,
determine a sensed location of the content rendering device,
perform comparisons of the sensed location to each of the set of specified locations, and
determine a level of rendering of digital content, in accordance with the set of rules, based on results of the comparisons.

13. The digital content rendering device according to claim 12, wherein the processor and associated instructions prohibit rendering of the digital content in accordance with a rule in the acquired set of rules, when a result of a comparison is a match between the sensed location and one of the set of specified locations.

14. The digital content rendering device according to claim 12, wherein the processor and associated instructions determine a first level of rendering according to a rule in the set of acquired rules when a result of a comparison is no match between the sensed location and any one of the set of specified locations and determine a second level of rendering according to a rule in the set of acquired rules when a result of a comparison is a match between the sensed location and any one of the set of specified locations.

15. The digital content rendering device according to claim 12, wherein the processor and associated instructions determine at least two levels of rendering according to the set of acquired rules, the at least two levels of rendering corresponding to comparisons between the sensed location and corresponding locations of the set of specified locations.

16. The digital content rendering device according to claim 12,
wherein the digital content is encrypted with a content key that is independent of the set of specified locations, and wherein the content key is encrypted with a public key of the content rendering device, and wherein the set of rules and the encrypted content key are cryptographically protected, and wherein the processor and associated instructions further:
determine the sensed location and perform the comparisons within a trusted platform;
verify the integrity of the set of rules and encrypted content key;
extract the content key from the encrypted content key using a private key of the content rendering device; and
decrypt the encrypted digital content using the content key.

17. The digital content rendering device according to claim 12, wherein the processor and associated instructions determine a result of a comparison as a match when the sensed location and one location of the set of specified locations differ by less than a proximity value.
